(19) United States
(12) Patent Application Publication
(10) Pub. No.: US 2026/0296435 A1
(43) Pub. Date: Oct. 1, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Toru Kokaki, Tokyo (JP); Takao Tamura, Tokyo (JP); Daichi Kato, Tokyo (JP)

(21) Appl. No.: 19/550,326

(22) Filed: Feb. 26, 2026

(30) Foreign Application Priority Data
Mar. 28, 2025 (JP) 2025-054753

(51) Int. Cl. B60W 30/18; B60W 10/20

(52) U.S. Cl. CPC B60W 30/18154; B60W 10/20; B60W 2540/10; B60W 2540/18; B60W 2552/10; B60W 2552/20; B60W 2556/10; B60W 2710/20; B60W 2720/10

(57) ABSTRACT

A vehicle control device according to an embodiment includes: a path determiner configured to determine a path of a vehicle; and a driving controller configured to execute travel control of the vehicle, in which the path determiner determines the path of the vehicle using one of a plurality of determination modes, and the plurality of determination modes include a first mode in which, when a road shape with a plurality of path candidates exists in a traveling direction and a destination has been set, a path in a direction of the destination is determined from among the plurality of path candidates, and a second mode in which, when the road shape exists and a destination has not been set, a path for the vehicle to travel is determined from among the plurality of path candidates according to a condition based on a predetermined road standard.

### CROSS-REFERENCE TO RELATED APPLICATION

Priority is claimed on Japanese Patent Application No. 2025-054753, filed Mar. 28, 2025, the content of which is incorporated herein by reference.

### BACKGROUND

### Field of the Invention

The present invention relates to a vehicle control device, a vehicle control method, or a storage medium.

### Description of Related Art

In recent years, there have been increasing attempts to provide access to a sustainable transportation system that takes into consideration the most vulnerable traffic participants. For this realization, research and development efforts are focused on further improving the safety and convenience of transportation through research and development related to automated driving technology. In relation to this, in the related art, in a driving support device that determines an automated driving mode on the basis of whether a destination has been set by the driver and controls the vehicle’s traveling on the basis of the determined automated driving mode, a technology is known in which, when a destination has not been set, the automated driving mode is determined to be automated driving along the vehicle’s current travel route or automated stopping (for example, Japanese Patent Publication No. 5382218).

### SUMMARY

In automated driving technology in the related art, when automated driving is executed, it is common for the vehicle to prioritize roads with wider road widths or to prioritize traveling straight ahead. However, according to the situation of the vehicle, there may be cases where it is not desirable to continue traveling on wider roads or straight ahead. Therefore, there is a problem that appropriate driving control may not be possible depending on the situation of the vehicle.

In order to solve the above-mentioned problem, one object of the present application is to provide a vehicle control device, a vehicle control method, and a storage medium that can execute more appropriate driving control according to a situation of a vehicle. Then, this will ultimately contribute to the development of a sustainable transportation system.

A vehicle control device, a vehicle control method, and a storage medium according to this invention employ the following configurations.
(1): A vehicle control device according to an aspect of the present invention is a vehicle control device including: a path determiner configured to determine a path of a vehicle according to a situation of the vehicle; and a driving controller configured to execute at least one of steering control and speed control of the vehicle such that the vehicle travels along the path determined by the path determiner, in which the path determiner determines the path of the vehicle using one of a plurality of determination modes, and the plurality of determination modes include a first mode in which, when a road shape with a plurality of path candidates exists in a traveling direction of the vehicle and a destination of the vehicle has been set, a path in a direction of the destination is determined from among the plurality of path candidates, and a second mode in which, when the road shape exists and a destination of the vehicle has not been set, a path for the vehicle to travel is determined from among the plurality of path candidates according to a condition based on a predetermined road standard.
(2): In the aspect of (1), the second mode may be a mode in which a path that continues a current path of the vehicle is determined from among the plurality of path candidates when a priority of a road standard of a road on which the vehicle is traveling is equal to or higher than a predetermined value, or when a priority of a road standard of a road on which the vehicle is traveling and a priority of a road standard of the path candidate are equal to each other or do not differ by a predetermined value or more.
(3): In the aspect of (1), the vehicle control device may further include an acquirer configured to acquire an operation by an occupant of the vehicle, in which the driving controller, when the acquirer acquires information about the destination of the vehicle through the operation by the occupant while the vehicle is traveling along the path determined in the second mode by the path determiner, causes the vehicle to travel along the path determined in the first mode.
(4): In the aspect of (1), the plurality of determination modes may include a third mode in which, when the vehicle is unable to travel on the path determined in the first mode, a path in the direction of the destination is determined from a remaining path candidate among the plurality of path candidates.
(5): In the aspect of (1), the vehicle control device may further include an acquirer configured to acquire an operation by an occupant of the vehicle, in which the driving controller, when the acquirer acquires an instruction of a path direction from the occupant of the vehicle while the vehicle is traveling along the path determined in the first mode or the second mode, causes the vehicle to travel along the acquired path direction.
(6): In the aspect of (1), the vehicle control device may further include an output controller configured to cause an output to output information about the path determined in the second mode.
(7): In the aspect of (1), the path determiner, when determining the path in the second mode, may determine the path of the vehicle from a plurality of path candidates that intersect a traveling lane of the vehicle, on the basis of a current traveling situation of the vehicle.
(8): In the aspect of (2), the path determiner may determine the predetermined value according to an instruction from an occupant of the vehicle.
(9): In the aspect of (1), the path determiner may determine the condition based on the road standard on the basis of a past travel history of the vehicle.
(10): In the aspect of (1), the path determiner, when determining the path of the vehicle in the second mode, may determine the path of the vehicle on the basis of the number of lanes or width for each path among the plurality of path candidates.
(11): A vehicle control method according to another aspect of the present invention is a vehicle control method that is executed by a computer, the vehicle control method including: determining a path of a vehicle according to a situation of the vehicle; executing at least one of steering control and speed control of the vehicle such that the vehicle travels along the determined path; and determining the path of the vehicle using one of a plurality of determination modes, in which the plurality of determination modes include a first mode in which, when a road shape with a plurality of path candidates exists in a traveling direction of the vehicle and a destination of the vehicle has been set, a path in a direction of the destination is determined from among the plurality of path candidates, and a second mode in which, when the road shape exists and a destination of the vehicle has not been set, a path for the vehicle to travel is determined from among the plurality of path candidates according to a condition based on a predetermined road standard.
(12): A storage medium according to another aspect of the present invention is a non-transitory computer-readable storage medium that stores a program, the program causing a computer to execute: determining a path of a vehicle according to a situation of the vehicle; executing at least one of steering control and speed control of the vehicle such that the vehicle travels along the determined path; and determining the path of the vehicle using one of a plurality of determination modes, in which the plurality of determination modes include a first mode in which, when a road shape with a plurality of path candidates exists in a traveling direction of the vehicle and a destination of the vehicle has been set, a path in a direction of the destination is determined from among the plurality of path candidates, and a second mode in which, when the road shape exists and a destination of the vehicle has not been set, a path for the vehicle to travel is determined from among the plurality of path candidates according to a condition based on a predetermined road standard.

According to the above aspects (1) to (12), more appropriate driving control can be executed according to the situation of the vehicle.

### BRIEF DESCRIPTION OF THE DRAWINGS

FIG. 1 is a configuration diagram of a vehicle system including a vehicle control device according to an embodiment.

FIG. 2 is a functional configuration diagram of a first controller and a second controller according to the embodiment.

FIG. 3 is a diagram for describing an example of determining a path and generating a target trajectory in a first mode.

FIG. 4 is a diagram for describing an example of determining a path and generating a target trajectory in a second mode.

FIG. 5 is a diagram illustrating an example of first information.

FIG. 6 is a diagram illustrating an example of second information.

FIG. 7 is a diagram illustrating an example of a road shape of a T-junction.

FIG. 8 is a diagram illustrating an example of a road shape provided with a left-turn connecting road.

FIG. 9 is a diagram illustrating an example of a road shape with a simple intersection and a special connection.

FIG. 10 is a diagram illustrating an example of a road shape of a Y-junction.

FIG. 11 is a diagram illustrating an example of a road shape of a modified Y-junction.

FIG. 12 is a diagram illustrating another example of a road shape of a modified Y-junction.

FIG. 13 is a diagram illustrating an example of a road shape of a circular intersection.

FIG. 14 is a diagram illustrating an example of traveling along a road in a situation where a destination has not been set.

FIG. 15 is a flowchart illustrating an example of a flow of processes executed by the automated driving control device.

### DESCRIPTION OF EMBODIMENTS

Hereinafter, embodiments of a vehicle control device, a vehicle control method, and a storage medium of the present invention will be described with reference to the accompanying drawings. For example, an embodiment in which the vehicle control device is applied to an automated driving vehicle will be described in the following description. For example, automated driving refers to executing driving control by automatically controlling one or both of steering and a speed of the vehicle. Examples of the above-described driving control may include driving control such as an Adaptive Cruise Control System (ACC), Traffic Jam Pilot (TJP), Lane Keeping Assistance System (LKAS), Automated Lane Change (ALC), and Collision Mitigation Brake System (CMBS). Further, in the automated driving vehicle, driving control according to a manual operation (so-called manual driving) of a user (for example, an occupant) of the vehicle may be executed. In the following description, a case will be described in which the left-hand traffic regulations are applied, but when the right-hand traffic regulations are applied, the left and right may simply be read in reverse.

### Overall Configuration

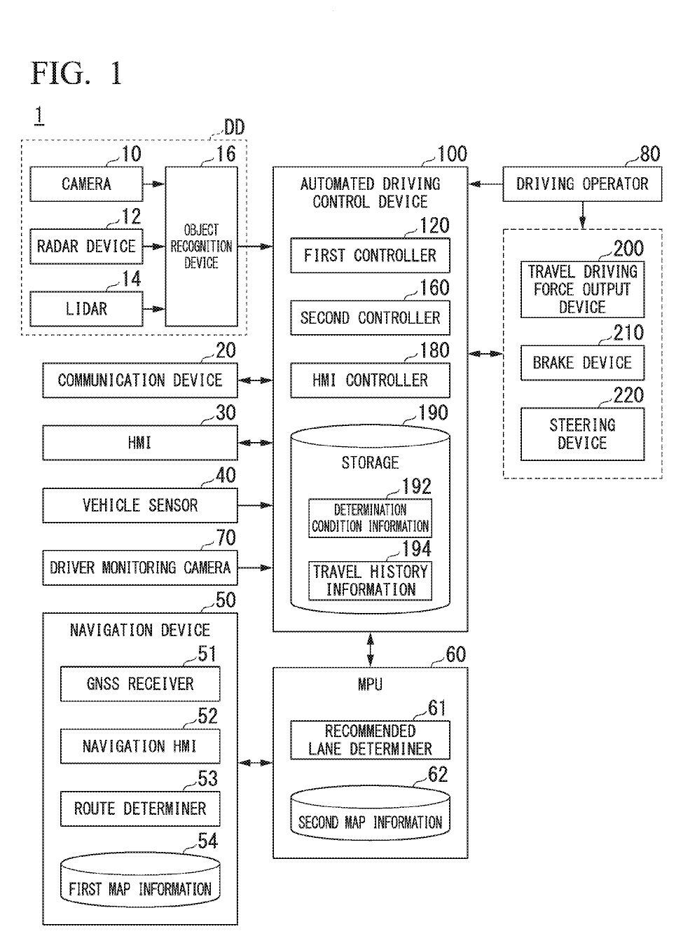

FIG. 1 is a configuration diagram of a vehicle system 1 including a vehicle control device according to an embodiment. A vehicle (hereinafter referred to as a vehicle M) in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a battery (storage battery) such as a secondary battery or a fuel cell is discharged.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices and equipment are connected to each other via multiplex communication lines, such as controller area network (CAN) communication lines, serial communication lines, wireless communication networks, or the like. Further, the configuration illustrated in FIG. 1 is merely an example, and some of the configuration may be omitted, or other configuration may be added. The camera 10 is an example of an “imager.” A combination of the camera 10, the radar device 12, the LIDAR 14, and the object recognition device 16 is an example of a “detection device DD.” The HMI 30 is an example of a “receiver” and an “output.” The automated driving control device 100 is an example of a “vehicle control device.”

For example, the camera 10 is a digital camera using a solid-state imaging element such as, for example, a charge-coupled device (CCD) or a complementary metal oxide semiconductor (CMOS). The camera 10 is attached to any location on the vehicle M in which the vehicle system 1 is mounted. For example, when the view in front of the vehicle M is imaged, the camera 10 is attached to an upper part of a front windshield, a rear surface of a rearview mirror, a front part of a vehicle body, or the like. When the view to the rear of the vehicle M is imaged, the camera 10 is attached to an upper part of a rear windshield, a back door, or the like. When the views to the side of the vehicle M are imaged, the camera 10 is attached to a door mirror, or the like. The camera 10 captures images of the surroundings of the vehicle M repeatedly, for example, periodically. The camera 10 may also be a stereo camera.

The radar device 12 emits radio waves such as millimeter waves around the vehicle M and detects radio waves reflected by surrounding objects (reflected waves) to detect at least the position (distance and orientation) of the objects. The radar device 12 is attached to the vehicle M at an arbitrary location. The radar device 12 may detect the position and speed of the object using a frequency modulated continuous wave (FM-CW) method.

The LIDAR 14 radiates light to the vicinity of the vehicle M and measures scattered light. The LIDAR 14 detects a distance to an object on the basis of a time from radiation of light to reception of light. The radiated light is, for example, a pulsed laser beam. The LIDAR 14 is attached to an arbitrary position of the vehicle M.

The object recognition device 16 executes sensor fusion processing on some or all of the detection results from the camera 10, the radar device 12, and the LIDAR 14 to recognize the position, type, speed, etc. of the object. The object recognition device 16 outputs the recognition results to the automated driving control device 100. The object recognition device 16 may output the results of detection from the camera 10, the radar device 12, and the LIDAR 14 to the automated driving control device 100 without any change. In this case, the object recognition device 16 may be omitted from a configuration of the vehicle system 1 (the detection device DD).

The communication device 20 communicates with other vehicles near the vehicle M, a terminal device of a user of the vehicle M, or various server devices, for example, using a network such as a cellular network, a Wi-Fi network, Bluetooth (registered trademark), dedicated short range communication (DSRC), a local area network (LAN), or a wide area network (WAN).

The HMI 30 outputs various types of information to the occupant of the vehicle M and receives input operations by the occupant. The HMI 30 includes, for example, various display devices, speakers, buzzers, touch panels, switches, keys, and microphones. Examples of the display device include a liquid crystal display (LCD) device and an organic electroluminescence (EL) display device. The display device is provided in the vicinity of the front of a driver’s seat (a seat closest to the steering wheel) on an instrument panel and is installed at a position which can be seen by an occupant through a gap of the steering wheel or over the steering wheel. In addition, the display device may be installed in a center of the instrument panel. In addition, the display device may also be a head up display (HUD). The HUD allows an occupant sitting on the driver’s seat to see a virtual image by projecting an image to a part of a front windshield in front of the driver’s seat. The display device displays an image which is generated by the HMI controller 180 which will be described later. Moreover, the HMI 30 may include a driving changeover switch or the like for switching between automated driving and manual driving by the occupant.

The vehicle sensor 40 includes a vehicle speed sensor configured to detect the speed of the vehicle M, an acceleration sensor configured to detect acceleration, a yaw rate sensor configured to detect a yaw rate (for example, a rotational angular velocity around a vertical axis passing through the center of gravity of the vehicle M), a direction sensor configured to detect the direction of the vehicle M, and the like. The vehicle sensor 40 may be provided with a position sensor that detects the position of the vehicle. The position sensor is, for example, a sensor that acquires position information (longitude and latitude information) from a global positioning system (GPS) device. Further, the position sensor may be a sensor that acquires position information using a global navigation satellite system (GNSS) receiver 51 of the navigation device 50. The vehicle sensor 40 may derive the speed of the vehicle M from a difference (that is, a distance) in position information at a predetermined time in the position sensor. A detection result of the vehicle sensor 40 is output to the automated driving control device 100.

The navigation device 50 includes, for example, a GNSS receiver 51, a navigation HMI 52, and a route determiner 53. The navigation device 50 stores first map information 54 in a storage device such as a hard disk drive (HDD) or a flash memory. The GNSS receiver 51 specifies a position of the vehicle M on the basis of the signal received from a GNSS satellite. The position of the vehicle M may be specified or supplemented by an inertial navigation system (INS) using the output of the vehicle sensor 40. The navigation HMI 52 includes a display device, a speaker, a touch panel, and keys. The GNSS receiver 51 may be provided in the vehicle sensor 40. The navigation HMI 52 may be partially or completely shared with the HMI 30 described above. The route determiner 53 determines, for example, a route (hereinafter, a route on map) to a destination input by an occupant using the navigation HMI 52 from a position of the vehicle M (or an arbitrary position that was input) specified by the GNSS receiver 51 with reference to the first map information 54. The first map information 54 is, for example, information that represents a shape of a road using links that indicate roads and nodes connected by the links. The first map information 54 may include point of interest (POI) information, and the like. The route on map is output to the MPU 60. The navigation device 50 may perform route guidance using the navigation HMI 52 on the basis of the route on map. The navigation device 50 may transmit the current position and destination to a navigation server via the communication device 20, and acquire the same route as the route on map from the navigation server. The navigation device 50 outputs a determined route on the map to the MPU 60.

The MPU 60 includes, for example, a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] in a traveling direction of the vehicle), and determines a recommended lane for each block with reference to the second map information 62. The recommended lane determiner 61 determines which lane from the left the vehicle travels on. The recommended lane determiner 61 determines the recommended lane such that the vehicle M can travel along a reasonable route for traveling to a branching destination when there is a branch point in the route on the map.

The second map information 62 is map information more accurate than the first map information 54. The second map information 62 includes, for example, the road type, number of lanes, type and shape of road lane markings (hereinafter referred to as lane markings), information on center of lanes, information on road boundaries, and the like. The second map information 62 may include road shape information, traffic regulation information, address information (address and zip code), facility information, parking lot information, telephone number information, and the like. Road shape information includes, for example, the type of intersection (crossroads, T-junctions, Y-junctions, circular intersections, etc.), branches, merging points, points where lanes increase or decrease, road curvature (which can also be referred to as radius of curvature; the same applies below), the amount of curvature change per predetermined distance, width, gradient, and the like.

The second map information 62 may also include information about lines indicating the center of lanes (center lines). The center line is the center line between the left and right lane markings. This center line may exist in a lane where either the left or right lane marking that defines the lane is discontinued.

The second map information 62 may be updated at any time by the communication device 20 communicating with an external device. The first map information 54 and the second map information 62 may be integrally provided as map information. The map information may be stored in the storage 190.

The driver monitoring camera 70 is, for example, a digital camera that uses a solid-state imaging element such as a CCD or a CMOS. The driver monitoring camera 70 is attached to an arbitrary position on the vehicle M in a place and a direction in which the head of an occupant (a driver) sitting on a driver’s seat of the vehicle M can be imaged from the front (such that the face of the driver is imaged). For example, the driver monitoring camera 70 is attached to an upper part of a display device which is provided at the center of the instrument panel of the vehicle M.

The driving operator 80 includes, for example, a steering wheel, an accelerator pedal, and a brake pedal. The driving operator 80 may include a shift lever, a modified steering wheel, a joystick, or other operators. An operation detector that detects an amount of operation with respect to the operator by the occupant or presence or absence of the operation, for example, is attached to each operator of the driving operator 80. The operation detector detects, for example, a steering angle or steering torque of the steering wheel, and an amount of depression of the accelerator pedal or the brake pedal. The operation detector outputs detection result to the automated driving control device 100 or one or both of the travel driving force output device 200, the brake device 210 and the steering device 220.

The automated driving control device 100 executes various driving controls belonging to automated driving for the vehicle M. The automated driving control device 100 includes, for example, a first controller 120, a second controller 160, an HMI controller 180, and a storage 190. The first controller 120, the second controller 160, and the HMI controller 180 are realized, for example, by causing a hardware processor such as a central processing unit (CPU) to execute a program (software). Further, some or all of these components may be realized by hardware (including circuitry) such as a large scale integration (LSI), an application specific integrated circuit (ASIC), a field-programmable gate array (FPGA), a graphics processing unit (GPU), or a system on chip (SOC), or may be realized by a combination of software and hardware. The program may be pre-stored in a storage device (a storage device including a non-transitory storage medium) such as an HDD or a flash memory of the automated driving control device 100 or may be stored in a removable storage medium such as a DVD, a CD-ROM, or a memory card and installed in the storage device of the automated driving control device 100 when the storage medium (the non-transitory storage medium) is mounted in a drive device, a card slot, or the like. The HMI controller 180 is an example of an “output controller.”

The storage 190 may be implemented by the above-described various storage devices, or an electrically erasable programmable read-only memory (EEPROM), a read-only memory (ROM), a random-access memory (RAM), or the like. The storage 190 stores, for example, determination condition information 192, travel history information 194, various types of information in the embodiment, programs, and the like. The determination condition information 192 includes, for example, information about the conditions for determining one of the paths when there are a plurality of paths in the traveling direction of the vehicle M. The travel history information 194 includes information about roads on which the vehicle M has traveled in the past. The travel history information 194 may be stored for each occupant of the vehicle M. The storage 190 may store map information (for example, the first map information 54 and the second map information 62).

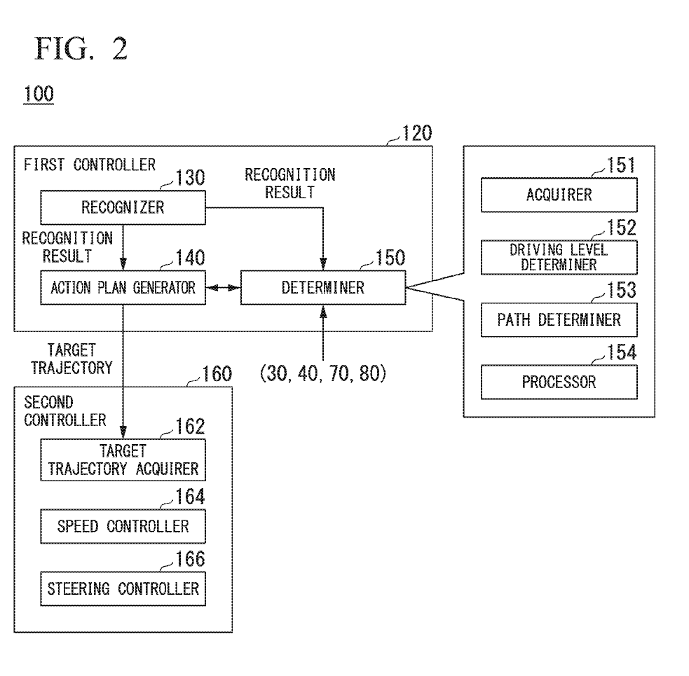

FIG. 2 is a diagram illustrating functional configurations of the first controller 120 and the second controller 160 according to the embodiment. The first controller 120 includes, for example, a recognizer 130, an action plan generator 140, and a driving level determiner 152. The first controller 120 performs functions based on, for example, artificial intelligence (AI) and a pre-defined model in parallel. For example, a function of “recognizing an intersection” may be realized by executing in parallel recognition of an intersection by deep learning or the like and recognition based on pre-given conditions (such as signals and road signs that can be pattern matched), and by scoring and comprehensively evaluating both.

The recognizer 130 recognizes a surrounding situation of the vehicle M on the basis of information input from the detection device DD. For example, the recognizer 130 recognizes states such as a position (a position relative to the vehicle M), a speed (a speed relative to the vehicle M), and an acceleration of an object (for example, another vehicle or a pedestrian) near the vehicle M (within a predetermined distance from the vehicle M). The position of the object, for example, is recognized as a position on absolute coordinates having a representative point of the vehicle M (a center of gravity, a drive shaft center, or the like) as the origin, and is used for control. The position of the object may be expressed by a representative point such as the center of gravity or a corner of the object, or may be expressed by an area. The “state” of the object may include acceleration or jerk of the object, or “a behavioral state” (for example, whether lane change is performed or to be performed). In addition, the recognizer 130 may also recognize stop lines, obstacles, red lights, toll gates, and other road events.

The recognizer 130 recognizes, for example, a lane (a traveling lane) in which the vehicle M is traveling. Here, for example, the recognizer 130 recognizes right and left lane markings of the vehicle M (when seen from the vehicle M) from an image captured by the camera 10 (hereinafter referred to as a camera image) and recognizes the traveling lane on the basis of positions of the recognized lane markings. For example, the recognizer 130 analyzes the camera image, extracts edge points of which a difference in luminance from neighboring pixels in the image is large, and recognizes a lane marking in an image plane by connecting the edge points. The recognizer 130 converts positions of lane markings relative to the representative point of the vehicle M to a vehicle coordinate system and recognizes a lane defined by the right and left lane markings closest to the vehicle M as the traveling lane. The recognizer 130 may recognize a neighboring lane adjacent to the traveling lane on the basis of the recognized lane markings. The recognizer 130 is not limited to the lane markings, but may recognize the traveling lane by recognizing objects (traveling lane boundaries or road boundaries) capable of identifying a lane position including edges of road shoulders, curbstones, median strips, guard rails, fences, walls, and the like from the result of analysis of the camera image.

The recognizer 130 recognizes lanes near the vehicle M including the traveling lane in which the vehicle M is traveling with reference to map information (for example, the second map information 62) on the basis of the position of the vehicle M detected by the vehicle sensor 40 or the GNSS receiver 51. The recognizer 130 may recognize lane markings defining the traveling lane or may recognize a neighboring lane adjacent to the traveling lane or lane markings defining the neighboring lane. The recognizer 130 may recognize centerlines of the traveling lane or the neighboring lane (lane centerlines) from the map information. In addition, the recognizer 130 may recognize the lanes and lane markings around the vehicle M by combining information about lanes and lane markings acquired from camera images with information about lanes and lane markings acquired from map information.

In addition, when the recognizer 130 recognizes the traveling lane, the recognizer 130 may recognize the position and posture of the vehicle M relative to the traveling lane. The recognizer 130 may recognize, for example, a deviation of the reference point of the vehicle M from the lane center and an angle of the traveling direction of the vehicle M relative to a line connecting the lane centers as the relative position and posture of the vehicle M with respect to the traveling lane. Instead, the recognizer 130 may recognize a position of a reference point of the vehicle M with respect to one side line of the traveling lane (a lane marking or a road boundary) or the like as the relative position of the vehicle M with respect to the traveling lane.

In addition, the recognizer 130 may recognize the road shape in the traveling direction of the vehicle M (for example, a straight road, a curved road, an intersection, etc.), and whether a road shape with a plurality of path candidates exists within a predetermined distance in the traveling direction. The recognizer 130 may also recognize the type of road around the vehicle M by referring to map information. Road types include, for example, expressways, expressway connecting roads, primary arterial roads, secondary arterial roads, tertiary arterial roads, residential roads, and other general roads.

In principle, the action plan generator 140 generates a target trajectory in which the vehicle M will automatically travel (without depending on an operation of the driver) in the future such that the vehicle M travels in a recommended lane determined by the recommended lane determiner 61 and can also cope with surrounding situations of the vehicle M. The target trajectory includes, for example, a speed element. For example, the target trajectory is represented as a sequence of points (trajectory points) that the vehicle M should reach. The trajectory point is a point that the vehicle M should reach for a predetermined traveling distance (for example, a few meters) along the road, and in addition, the target speed and target acceleration are generated as part of the target trajectory for each predetermined sampling time (for example, a few tenths of a second). In addition, the trajectory point may be the position that the vehicle M should reach at each predetermined sampling time. In this case, information on the target speed and target acceleration is expressed as an interval between trajectory points.

The action plan generator 140 may set events (functions) of automated driving in generating a target trajectory. The events of automated driving include a constant-speed travel event, a low-speed following travel event, a lane change event, a branching event, a merging event, and an overtaking event. The action plan generator 140 generates a target trajectory according to a triggered event. The action plan generator 140 generates the target trajectory such that driving control corresponding to details determined by the driving level determiner 152 can be executed.

A determiner 150 includes, for example, an acquirer 151, a driving level determiner 152, a path determiner 153, and a processor 154. The action plan generator 140, the processor 154, and the second controller 160 are examples of a “driving controller.”

The acquirer 151 acquires the recognition results recognized by the recognizer 130, the detection results of the vehicle sensor 40, and the like. In addition, the acquirer 151 acquires the operation details of the occupant of the vehicle M from, for example, the HMI 30, the driving operator 80, etc. The operation details include, for example, information about the control of the vehicle M, such as the operation of switching the driving level, which will be described later, and the conditions for determining the path at the time of traveling. Furthermore, the operation detail may be, for example, information about a destination input via the navigation device 50. In this case, the acquirer 151 may acquire information on whether a destination has been input by an occupant, and when a destination has been input, may acquire information on the specific location of the destination. The acquirer 151 may also acquire an image of the occupant captured from the driver monitoring camera 70.

The driving level determiner 152 determines the driving level of the vehicle M to be one of a plurality of driving levels (in other words, a plurality of levels with different degrees of automation) that impose different tasks on the driver, on the basis of information acquired by the acquirer 151, etc.

The driving level of the vehicle M includes a plurality of levels, including, for example, a first driving level and a second driving level. The first driving level has a higher control state of the vehicle M, that is, a higher degree of automation (degree of control) of the driving control of the vehicle M, than the second driving level. In other words, the first driving level imposes a lighter task on an occupant (driver) than the second driving level. The first driving level may include automated driving, and the second driving level may include manual driving. When the first driving level is control related to automated driving and the first driving level is switched to the second driving level, the automated driving control device 100 is responsible for ending the control related to automated driving and transitioning to manual driving.

Here, the first driving level and the second driving level will be specifically described. At the first driving level, neither monitoring of the surroundings of the vehicle M nor gripping of the steering wheel (hereinafter referred to as “steering grip”) needs to be imposed on an occupant. In addition, at the first driving level, there may be a restriction where the task of monitoring the surroundings of the vehicle M (hereinafter referred to as “surroundings monitoring”) is imposed on the occupant, while the task of gripping the steering wheel is not imposed. For example, at the first driving level, the vehicle system 1 may perform lane changes (ALC), left/right turn control, lane keep assist (LKAS), and the like of the vehicle M based on route settings to a destination by the navigation device 50 or the like, under a determination made on the side of the vehicle system 1 without receiving lane change instructions from the occupant (without receiving driving operations by the occupant). Furthermore, at the first driving level, even when a destination has not been set, automated driving may be performed in which the vehicle travels along the road (path) on the basis of predetermined path determination conditions.

At the second driving level, the task of monitoring the surroundings and gripping the steering wheel is imposed on the occupant. The second driving level may be a level that requires a certain degree of driving operation by the occupant regarding at least one of steering and accelerating/decelerating the vehicle M. In addition, the second driving level may be a manual driving state (manual driving mode) in which driving operations by the occupant are required for both steering and accelerating/decelerating the vehicle M. Furthermore, the driving level may be, for example, three or more driving levels obtained by further dividing the first driving level or the second driving level according to conditions.

When the driver does not execute a task related to the determined driving level, the driving level determiner 152 changes the driving level to one with a more severe task. For example, when, while the first driving level is being executed, the occupant is in a position where he/she is unable to transition to manual driving in response to a request from the system (for example, when he/she continues to look away from the vehicle outside the permitted area or when signs of difficulty in driving are detected), the driving level determiner 152 causes the HMI controller 180 to use the HMI 30 to execute control to prompt the occupant to transition to manual driving, which is the second driving level. The driving level determiner 152 performs control such as gradually decelerating the vehicle M while moving the vehicle M toward a target position (for example, a road shoulder) and stopping automated driving when the occupant does not respond within a predetermined time after the HMI controller 180 has been caused to perform control for prompting transition to manual driving or when it is estimated that the occupant does not take a posture for manual driving. After automated driving has been stopped, the vehicle M enters a state of the second driving level, and the vehicle M can be started by manual operation by the occupant.

The path determiner 153 determines the path of the vehicle M according to the situation of the vehicle M on the basis of the information acquired by the acquirer 151 and the information determined by the driving level determiner 152. For example, when the driving level determined by the driving level determiner 152 is the first driving level, the path determiner 153 determines a traveling mode according to the situation of the vehicle M. The function of the path determiner 153 will be described in detail later.

The processor 154 executes various processes on the basis of the driving level determined by the driving level determiner 152 and the path determined by the path determiner 153. For example, the processor 154 performs various processes to change the driving level determined by the driving level determiner 152 and to maintain the current driving level. For example, the processor 154 causes the action plan generator 140 to generate a target trajectory for the vehicle M to travel, and outputs information to the HMI 30 via the HMI controller 180, such as information to prompt the occupants to execute tasks according to their driving level, and information about the path determined by the path determiner 153 (for example, information about the path determined in a second mode described later). By outputting various types of information related to the processes executed in the embodiment from the HMI 30, it is possible to curb the discomfort felt by the occupants due to the driving control. Furthermore, even in a situation where a destination has not been set, the future path determined by the path determiner 153 can be notified.

The processor 154 also stores information such as road standards on which the vehicle M has traveled, a travel date and time, and a travel distance as the travel history information 194 in the storage 190. At this time, the processor 154 may store the travel history information 194 for each occupant of the vehicle M. Furthermore, the processor 154 may store the travel history information 194 for each driving level.

The action plan generator 140 generates a target trajectory for the vehicle M to travel on the basis of the information determined by the determiner 150, the recognition results of the recognizer 130, and the like.

The second controller 160 controls the travel driving force output device 200, the brake device 210, and the steering device 220 such that the vehicle M passes through the target trajectory generated by the action plan generator 140 at the scheduled time.

The second controller 160 includes, for example, a target trajectory acquirer 162, a speed controller 164, and a steering controller 166. The target trajectory acquirer 162 acquires information on the target trajectory (trajectory points) generated by the action plan generator 140 and stores the information on the target trajectory in a memory (not illustrated). The speed controller 164 controls the travel driving force output device 200 or the brake device 210 on the basis of the speed element associated with the target trajectory stored in the memory. The steering controller 166 controls the steering device 220 according to the curvature of the target trajectory stored in the memory. The processing of the speed controller 164 and the steering controller 166 is realized, for example, by a combination of feed-forward control and feedback control. For example, the steering controller 166 performs control in combination of feed-forward control based on a curvature of a road in front of the vehicle M and feedback control based on a separation from the target trajectory.

Referring back to FIG. 1, the HMI controller 180 uses the HMI 30 to notify the occupant of predetermined information. The predetermined information includes, for example, information about the traveling of the vehicle M, such as information about the state of the vehicle M and information about driving control. For example, the information related to the state of the vehicle M includes a speed of the vehicle M, an engine speed, a shift position, and the like. In addition, information about driving control includes, for example, inquiries regarding whether to change lanes, whether to execute a driving level, information about changes to the driving level, information imposed on the occupant necessary to switch the driving level (task request information for the occupant), information about the situation of driving control (for example, the detail of the driving level being executed), and the like. The information about driving control may also include information about the path determined by the path determiner 153 and information about the route (road) selected by the currently executing determination mode. Furthermore, the predetermined information may include information that is not related to the driving control of the vehicle M, such as a television program, contents (for example, movies) stored in a storage medium such as a DVD. The predetermined information may include, for example, a current position or a destination of the vehicle M and information on an amount of fuel remaining.

For example, the HMI controller 180 may generate an image including the aforementioned predetermined information and display the generated image on a display device of the HMI 30, or may generate vocal sound indicating the predetermined information and output the generated vocal sound from a speaker of the HMI 30. In addition, the HMI controller 180 may output information received by the HMI 30 to the communication device 20, the navigation device 50, the first controller 120, and the like.

The travel driving force output device 200 outputs a travel driving force (torque) to the driving wheels such that the vehicle travels. The travel driving force output device 200 includes, for example, a combination of an internal combustion engine, an electric motor, a transmission, and an electronic controller (ECU) that controls these. The ECU controls the above configuration according to the information input from the second controller 160 or the information input from the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to the information input from the second controller 160 or the information input from the driving operator 80 such that the brake torque corresponding to the braking operation is output to each wheel. The brake device 210 may include a backup mechanism that transmits hydraulic pressure generated by operating a brake pedal included in the driving operator 80 to a cylinder via a master cylinder. Further, the brake device 210 is not limited to the configuration described above, but may be an electronically controlled hydraulic brake device that controls the actuator according to information input from the second controller 160 and transmits the hydraulic pressure of the master cylinder to the cylinder.

The steering device 220, for example, includes a steering ECU and an electric motor. The electric motor, for example, applies a force to a rack and pinion mechanism to change the direction of the steered wheels. The steering ECU drives the electric motor and changes the direction of the steered wheels according to the information input from the second controller 160 or the information input from the driving operator 80.

### Path Determiner

Next, the function of the path determiner 153 will be described in detail. In the following description, the function of the path determiner 153 when the first driving level (automated driving) is being executed will be mainly described. The path determiner 153 determines the path of the vehicle M using one of a plurality of pre-set determination modes to determine the path of the vehicle M on the basis of surrounding situations such as the road shape in the traveling direction of the vehicle M recognized by the recognizer 130, and instructions from the occupants of the vehicle M acquired by the acquirer 151.

Here, the plurality of determination modes include, for example, a first mode in which, when a road shape with a plurality of path candidates exists in the traveling direction of the vehicle M and a destination of the vehicle M has been set, a path in a direction of the destination is determined from among the plurality of path candidates, and a second mode in which, when a road shape with a plurality of path candidates exists and a destination of the vehicle M has not been set, a path for the vehicle M to travel is determined from among the plurality of path candidates on the basis of a predetermined road standard and the like. A road shape with a plurality of path candidates is, for example, an intersecting road where a plurality of lanes, including the traveling lane, intersect, and is a road shape where there are routes other than going straight, such as crossroads such as intersections, T-junctions, and Y-junctions (for example, routes that require turning right or left). Furthermore, a road shape with a plurality of path candidates may include a circular intersection (a roundabout).

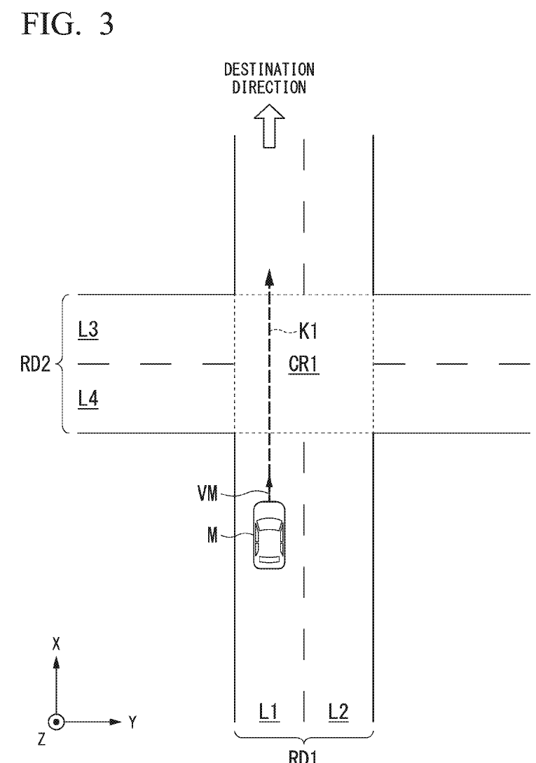

FIG. 3 is a diagram for describing an example of determining a path and generating a target trajectory in the first mode. The example of FIG. 3 illustrates an intersecting road (more specifically, a crossroad) where a road RD1 and a road RD2 intersect at an intersection CR1. The road RD1 has a lane L1 that can be traveled on along an X-axis direction in the drawing and a lane L2 that is an opposite lane to the lane L1, and the road RD2 has a lane L3 that can be traveled on along a Y-axis direction in the drawing and a lane L4 that is an opposite lane to the lane L3. Also, in the FIG. 3, it is assumed that the vehicle M is traveling on the lane L1 at a speed VM toward the intersection CR1 (that is, a road shape with a plurality of path candidates exists within a predetermined distance in the traveling direction of the vehicle M). In the example of FIG. 3, it is assumed that the driving control of the vehicle M is being executed at a first driving level.

In the example of FIG. 3, when the destination has already been set by the occupant of the vehicle M, the path determiner 153 determines a path in the direction of the destination at the intersection CR1. In the example of FIG. 3, the path is determined to go straight through the intersection CR1 in the direction of the destination (continue traveling on the lane L1). Then, the action plan generator 140 generates a target trajectory K1 such that the vehicle M travels along the determined path.

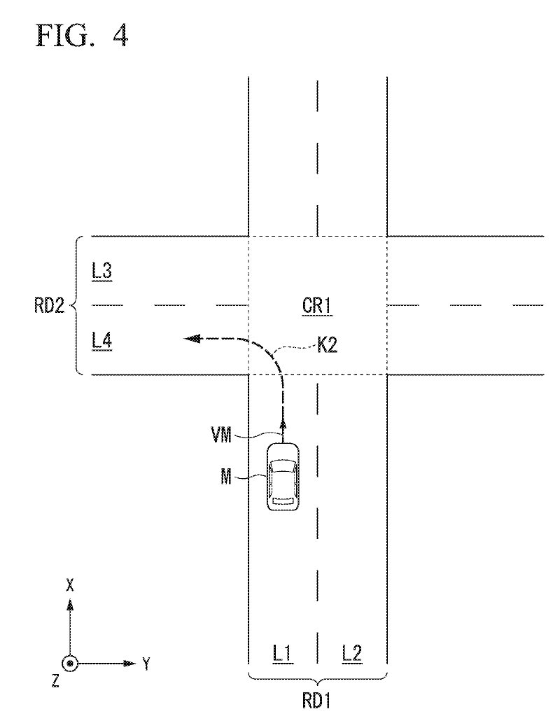

FIG. 4 is a diagram for describing an example of determining a path and generating a target trajectory in the second mode. In the example of FIG. 4, a vehicle M is traveling on a road having the same road shape as that of FIG. 3. When the destination of the vehicle M has not been set, the path determiner 153 determines the road on which the vehicle M will travel beyond the intersection CR1 on the basis of preset determination condition information 192. The determination condition information 192 includes, for example, first information 192A regarding priority based on road standards, and second information 192B regarding road rank based on a comparison between roads including traveling lanes and intersecting roads.

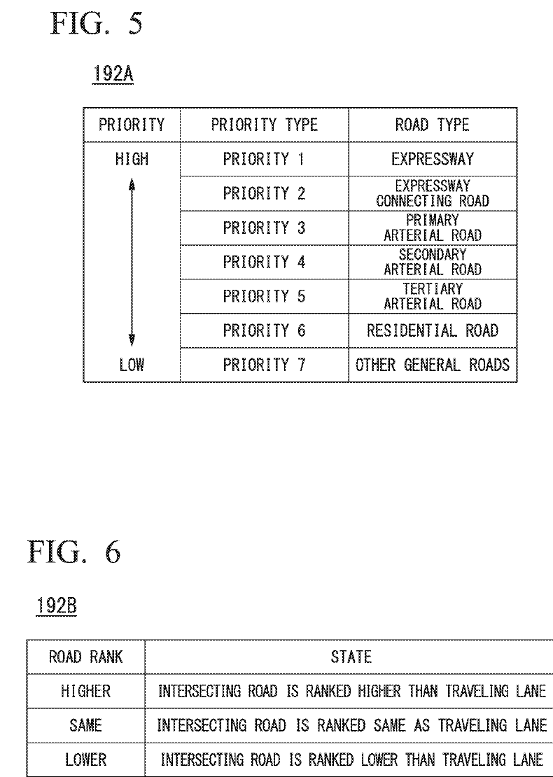

FIG. 5 is a diagram illustrating an example of the first information 192A. In the first information 192A illustrated in FIG. 5, for example, priority, priority type, and road type are associated with each other. The road type is information about road standards, and is information that can be acquired from map information (first map information 54, second map information 62), for example. In the example of FIG. 5, priorities 1 to 7 are assigned in descending order of priority, with priority 1 corresponding to the road type “expressway,” priority 2 corresponding to the road type “expressway connecting road,” priority 3 corresponding to the road type “primary arterial road,” priority 4 corresponding to the road type “secondary arterial road,” priority 5 corresponding to the road type “tertiary arterial road,” priority 6 corresponding to the road type “residential road,” and priority 7 corresponding to the road type “other general roads.” The number of priorities and the road types assigned to each priority in the embodiment are not limited to the example illustrated in FIG. 5.

FIG. 6 is a diagram illustrating an example of the second information 192B. The second information 192B illustrated in FIG. 6 associates, for example, road rank with the state of the traveling lane and the state of the intersecting road. For example, a rank of “higher” indicates that the intersecting road is ranked higher than the traveling lane (or the road containing the traveling lane), a rank of “same” indicates that the intersecting road is ranked the same as the traveling lane, and a rank of “lower” indicates that the intersecting road is ranked lower than the traveling lane. This road rank may be determined, for example, according to the priority included in the first information 192A. For example, when the priority type of a road (for example, the road RD1) including the traveling lane is “priority 4,” and the priority type of an intersecting road (for example, the road RD2) is “priority 3,” “priority 2,” or “priority 1,” the road rank of the intersecting road will be “higher,” when the priority type is “priority 4,” the road rank of the intersecting road will be “same,” and when the priority type is “priority 5,” “priority 6,” or “priority 7,” the road rank of the intersecting road will be “lower.” The road rank may be set on the basis of other criteria. Furthermore, the determination condition information 192 may not include the second information 192B.

When determining the path in the second mode, the path determiner 153 determines the path of the vehicle M when passing through the intersection CR1 using at least one of the first information 192A and the second information 192B. For example, the path determiner 153 acquires the road types of the roads RD1 and RD2 connected to the intersection CR1 on the basis of the position information of the vehicle M, and acquires the priority associated with the acquired road types. Then, the path determiner 153 determines the path (traveling direction) of the vehicle M on the basis of the acquired priority. In addition, the path determiner 153 may use the second information 192B to acquire a road rank according to the priority type of each of the road including the traveling lane and the intersecting road, and determine the path of the vehicle M on the basis of the acquired road rank.

For example, the path determiner 153 determines a path such that the vehicle M travels on a road with a higher priority. For example, when the priority type of the traveling lane is “priority 4,” the priority types of the “higher” intersecting road ranks will be “priority 1,” “priority 2,” and “priority 3,” the “same” will be “priority 4,” and the “lower” will be “priority 5,” “priority 6,” and “priority 7.” For example, when a lane on the road RD2 (a lane other than the traveling lane) is lower than or the same as the traveling lane L1, the path determiner 153 determines the current lane L1 as the path, and when a lane on the road RD2 is higher than the traveling lane L1, the path determiner 153 determines a lane included in the road RD2 as the path. In addition, when the road RD2 includes a plurality of lanes, the path determiner 153 selects a lane in a predetermined direction as seen from the vehicle M. In addition, the path determiner 153 may determine a lane that does not pass through other lanes (for example, an opposite lane) as the path of the vehicle M. This allows the vehicle M to move in a direction with less risk and greater safety.

In the example of FIG. 4, the road rank of the road RD2 is higher than that of the road RD1. Therefore, the path determiner 153 determines the path of the vehicle M to be road RD2, and further determines the lane L4 as the path because, of the lanes L3 and L4 included in the road RD2, the lane L4 does not pass through the lane L2, that is an opposite lane to the lane L1. The action plan generator 140 generates a target trajectory K2 for turning left at the intersection CR1 and traveling on the lane L4, and outputs the generated target trajectory K2 to the second controller 160 to execute driving control. This allows the driving control at the first driving level to be continued even when a destination has not been set on a road shape where an intersecting road or the like exists. Furthermore, since the conditions for the determination are clarified by determining the path on the basis of road standards, discomfort felt by occupants can be reduced, and since the vehicle can continue traveling along the road, the range of candidate destinations can be expanded.

In addition, in the second mode, when the priority of the road standard of the road on which the vehicle M is currently traveling is equal to or higher than a predetermined value, the path determiner 153 may determine the road currently being traveled on (current path) as the path for the vehicle M to continue traveling on even when the road rank of the intersecting road is higher than that of the road on which the vehicle M is currently traveling. In addition, in the second mode, the path determiner 153 may determine the road currently being traveled on (current path) as the path for the vehicle M to continue traveling on when the priority of the road standard of the road on which the vehicle M is currently traveling and the priority of the road standard of a plurality of path candidates are equal to each other or do not differ by a predetermined value or more. This can curb a situation where a right or left turn is required every time an intersecting road exists. Therefore, it is possible to reduce the discomfort felt by the occupants of the vehicle M, and to curb a situation in which the vehicle M traveling on a higher road than the occupants intended, such as on an expressway.

In addition, the path determiner 153 determines the above-mentioned predetermined value according to instructions from the occupant of the vehicle M. This makes it easier to determine a path in accordance with the intentions of the occupants. In addition, since the occupant can switch the predetermined value according to a traveling situation of the vehicle M, etc., the discomfort felt by the occupant due to the driving control can be reduced. The path determiner 153 may also refer to the travel history information 194 stored in the storage 190 and determine the predetermined value on the basis of the travel history for each road standard included in the travel history information 194. In this case, the path determiner 153 determines the predetermined value such that a path with a high travel frequency (above the predetermined value) is more likely to be determined. This allows the vehicle to travel along a path that the occupant prefers. The predetermined value may be a fixed value.

In addition, for example, when the driving control returns to the first driving level after switching from the first driving level (automated driving) to the second driving level (manual driving) (after being overridden), the path determiner 153 may determine the path within a predetermined time (for example, within approximately 1.0 [sec]) after the return. Accordingly, even when manual driving is temporarily performed, the path is determined immediately after the return and driving control at the first driving level is executed, thereby realizing more appropriate driving control.

Furthermore, when determining the path in the second mode, the path determiner 153 may determine the path on the basis of the road shape instead of (or in addition to) the determination condition information 192 described above. The path determination method will be described below using several examples of road shapes.

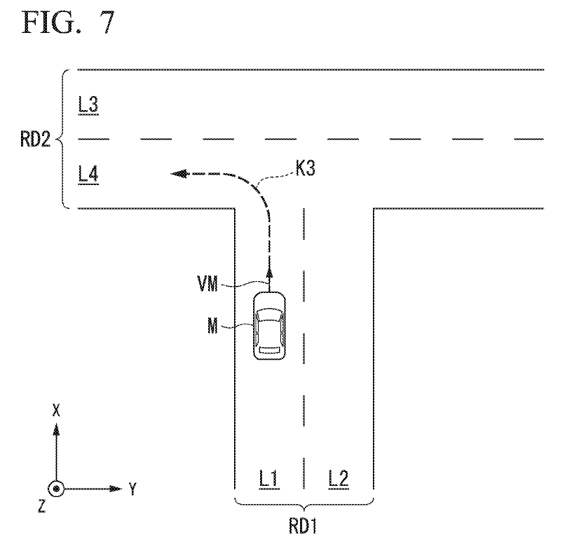

FIG. 7 is a diagram illustrating an example of a road shape of a T-junction. In the example of FIG. 7, a road RD1 connects to a road RD3, and the road RD1 is shaped such that it is not possible to go straight through the connecting section (the vehicle M traveling on a lane L1 toward a T-junction always needs to turn right or left). When the road shape with a plurality of path candidates in the traveling direction of the vehicle M is a T-junction, if the vehicle M reaches the junction, it will be necessary to turn right or left regardless of the road ranks of the roads RD1 and RD2 (that is, whether the road RD2 has a lower, same, or higher road rank than the road RD1). Therefore, when traveling through a T-junction, the path determiner 153 determines whether to turn right or left. In the example of FIG. 7, a lane L4 that does not pass through any lanes other than the lane of the intended path is determined as the path, and a target trajectory K3 for making the vehicle M turn left is generated.

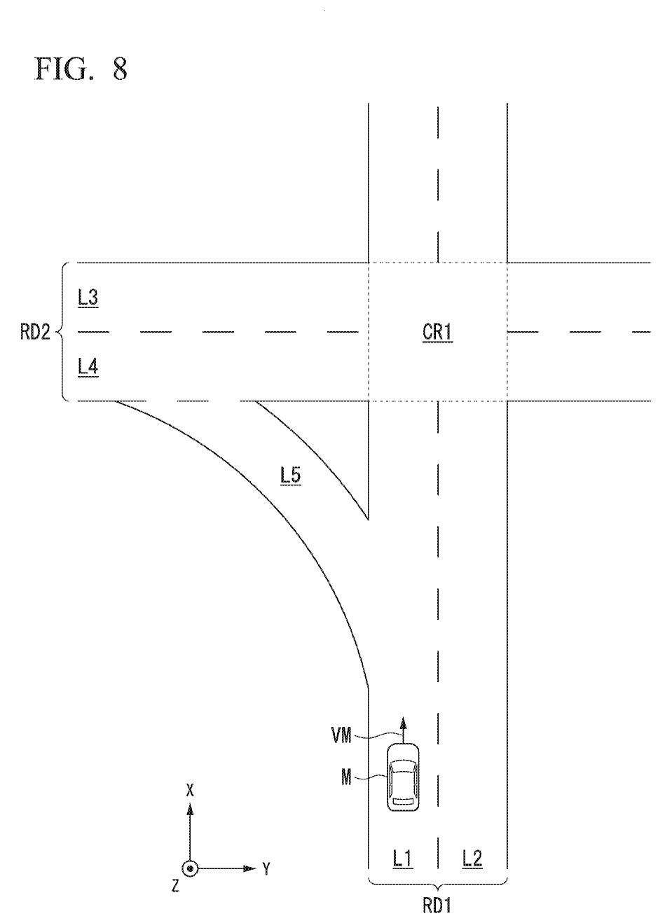

FIG. 8 is a diagram illustrating an example of a road shape provided with a left-turn connecting road. In the example of FIG. 8, roads RD1 and RD2 are connected at an intersection CR1, and in addition, a lane L5 is provided as a connecting road that allows travel from a lane L1 to a lane L4 without passing through the intersection CR1. In the case of the road shape illustrated in FIG. 8, as in the case of the road shape illustrated in FIG. 4, the path determiner 153 compares the road ranks (or priorities) of the roads RD1 and RD2 to determine the traveling direction of the vehicle M. For example, when the road rank of the road RD2 is “lower” than or “the same” as the rank of the road RD1, the path determiner 153 determines the lane L1 as the path for the vehicle M to continue traveling on, and when the road RD2 is “higher,” the path determiner 153 determines the lane L4 as the path for traveling on. In addition, when the lane L4 is determined as the path for traveling on and the position of the vehicle M is before reaching the lane L5, the action plan generator 140 generates a target trajectory that passes through the lane L5 and merges into the lane L4.

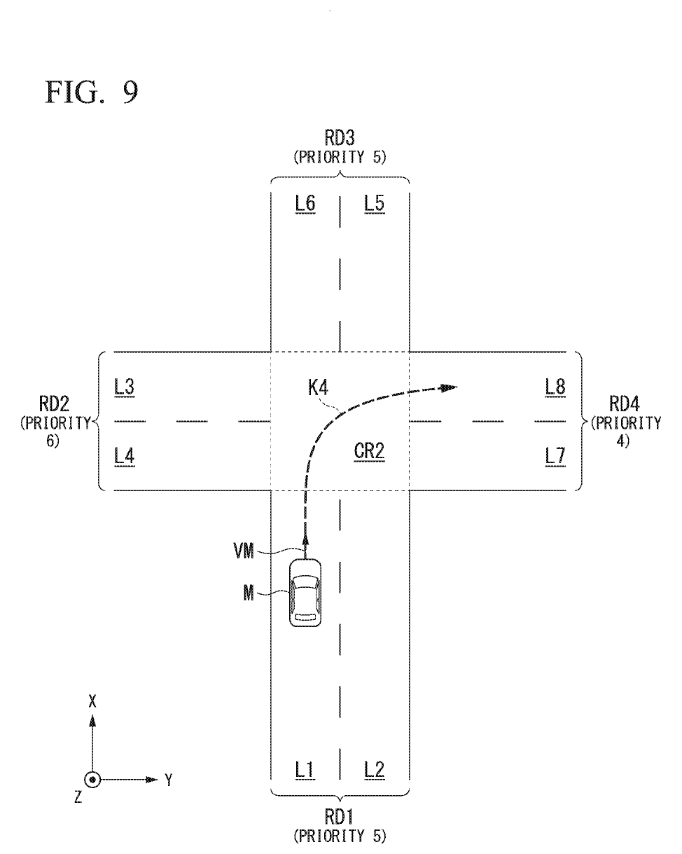

FIG. 9 is a diagram illustrating an example of a road shape with a simple intersection and a special connection. In the example of FIG. 9, a crossroad is illustrated as a simple intersecting road, and roads RD1, RD2, RD3, and RD4 are connected to an intersection CR2. In the example of FIG. 9, the road RD1 has a lane L1 that can be traveled on in the direction toward the intersection CR2 and a lane L2 that is an opposite lane to the lane L1, the road RD2 has a lane L3 that can be traveled on in the direction toward the intersection CR2 and a lane L4 that is an opposite lane to the lane L3, the road RD3 has a lane L5 that can be traveled on in the direction toward the intersection CR2 and a lane L6 that is an opposite lane to the lane L5, and the road RD4 has a lane L7 that can be traveled on in the direction toward the intersection CR2 and a lane L8 that is an opposite lane to the lane L7. In the example of FIG. 9, the road RD3 is located opposite the road RD1, and the road RD4 is located opposite the road RD2, with an intersection CW2 in between. In the example of FIG. 9, the roads RD1 and RD3 are connected to the roads RD2 and RD4 at right angles, and the roads RD2 and RD4 are connected in a special manner according to different road standards. In the example of FIG. 9, it is assumed that the vehicle M is traveling in the lane L1 at a speed VM.

In the example of FIG. 9, the path determiner 153 acquires the priority types of the roads RD1, RD2, RD3, and RD4, and determines the road with the highest acquired priority as the path of the vehicle M. For example, it is assumed that the priority type of the road RD1 is “priority 5,” the priority type of the road RD2 is “priority 6” (lower than the road RD1), the priority type of the road RD3 is “priority 5” (same as the road RD1), and the priority type of the road RD4 is “priority 4” (higher than the road RD1). In this case, the path determiner 153 determines, as the path, the road RD4 with the highest priority among the roads RD2 to RD4. Then, the action plan generator 140 generates a target trajectory K4 for traveling on the lane L8 of the road RD4.

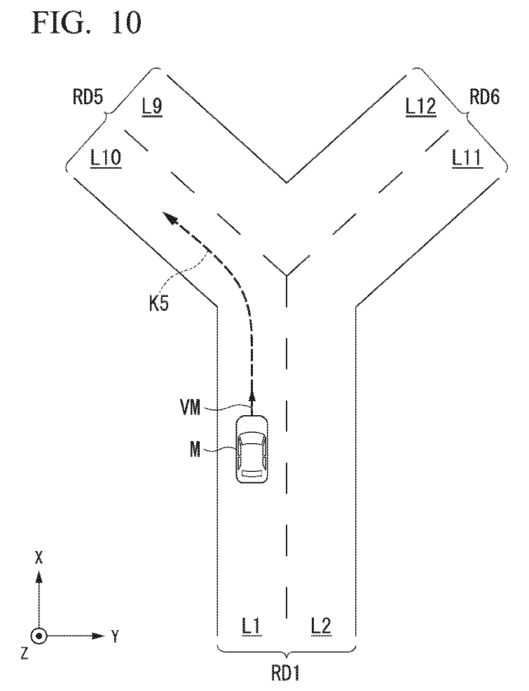

FIG. 10 is a diagram illustrating an example of a road shape of a Y-junction. In the example of FIG. 10, roads RD1, RD5, and RD6 are connected at angles other than right angles. This Y-junction is a road where it is possible to travel from at least one road (for example, the road RD1) to another road (the road RD5 or RD6). The road RD5 has a lane L9 that can be traveled toward the road RD1 and a lane L10 that is an opposite lane to the lane L9, and the road RD6 has a lane L11 that can be traveled toward the road RD1 and a lane L12 that is an opposite lane to the lane L11.

In the case of a Y-junction as illustrated in FIG. 10, when the vehicle M is traveling in the lane L1 at a speed VM toward a junction with the roads RD5 and RD6, the path determiner 153 determines, as the path, the road RD5 in a predetermined one direction (for example, the left direction), regardless of the priorities of the roads RD1, RD5, and RD6. The action plan generator 140 generates a target trajectory K5 for traveling along a lane L10 included in the road RD5, which is the determined path.

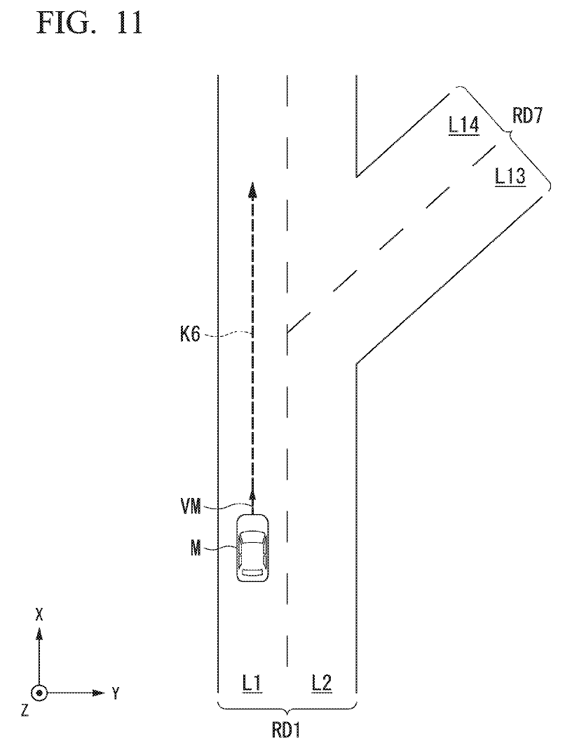

FIG. 11 is a diagram illustrating an example of a road shape of a modified Y-junction. In the example of FIG. 11, a road RD7 is connected to a road RD1 on the lane L2 side at an acute angle to the traveling direction of the vehicle M. The road RD7 has a lane L13 that can be traveled toward the road RD1 and a lane L14 that is an opposite lane to the lane L13. In the road shape illustrated in FIG. 11, when traveling from the lane L1 of the road RD1 to the lane L14 of the road RD7, it is necessary to pass through another lane (the lane L2). In the case of the road shape illustrated in FIG. 11, when the vehicle M is traveling in the lane L1 at a speed VM toward a junction with the road RD7, the path determiner 153 determines the road RD1 as the path, giving priority to the left direction, regardless of the priority of the road RD7. The action plan generator 140 generates a target trajectory K6 for continuing to travel along the lane L1, which is the determined path.

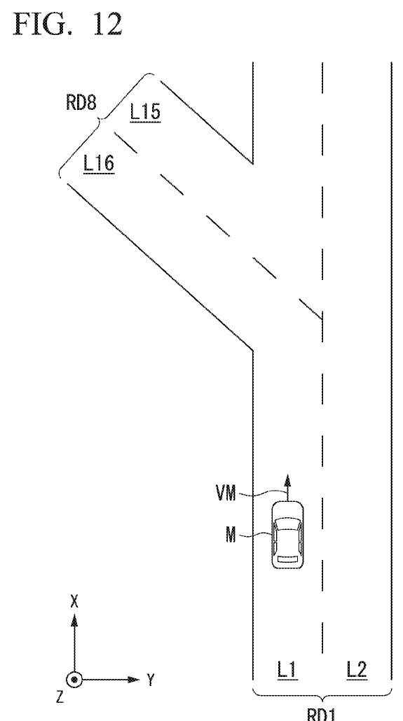

FIG. 12 is a diagram illustrating another example of a road shape of a modified Y-junction. In the example of FIG. 12, a road RD8 is connected to a road RD1 on the lane L1 side at an acute angle to the traveling direction of the vehicle M. The road RD8 has a lane L15 that can be traveled toward the road RD1 and a lane L16 that is an opposite lane to the lane L15. In the road shape illustrated in FIG. 12, when traveling from the lane L1 of the road RD1 to the lane L16 of the road RD8, it is not necessary to pass through another lane. In the case of the road shape illustrated in FIG. 12, when the vehicle M is traveling in the lane L1 at a speed VM toward a junction with the road RD8, the path determiner 153 acquires the road ranks of the roads RD1 and RD8, and when the road rank of the road RD8 is “the same” or “higher” than that of the road RD1, determines the road RD8 as the path, and when the road rank of the road RD8 is “lower,” determines the road RD1 as the path. In the example of FIG. 12, the path determiner 153 may determine the path on the basis of the priority of the road instead of the road rank.

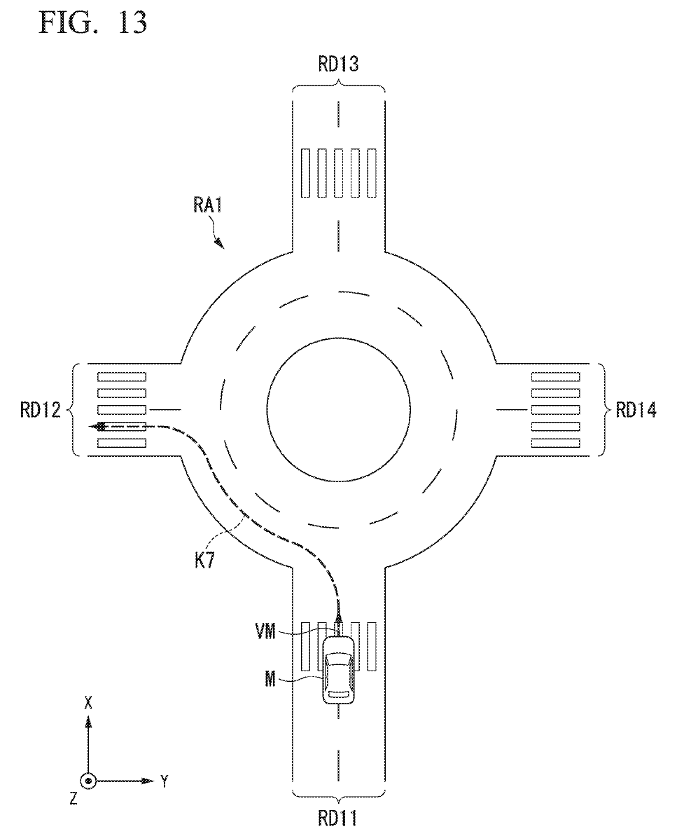

FIG. 13 is a diagram illustrating an example of a road shape of a circular intersection. At a circular intersection RA1 illustrated in FIG. 13, four roads RD11 to RD14 are connected to form a circular road portion. It is assumed that the vehicle M is traveling on the road RD11 at a speed VM toward the circular intersection RA1. When the circular intersection RA1 exists in the traveling direction, the path determiner 153 determines the road RD12 at the first exit immediately after entering the circular road portion as the path, regardless of the road rank or the priority. The action plan generator 140 generates a target trajectory K7 for traveling along the road RD12, which is the determined path.

As described above, according to the embodiment, even when automated driving is being executed in a situation where a destination has not been set (driving control is being executed using the first driving level) and there is a road shape with a plurality of path candidates in the traveling direction of the vehicle M, a more appropriate path can be determined according to the road standard, the road shape, and the like, and the vehicle can continue to travel along the road using automated driving.

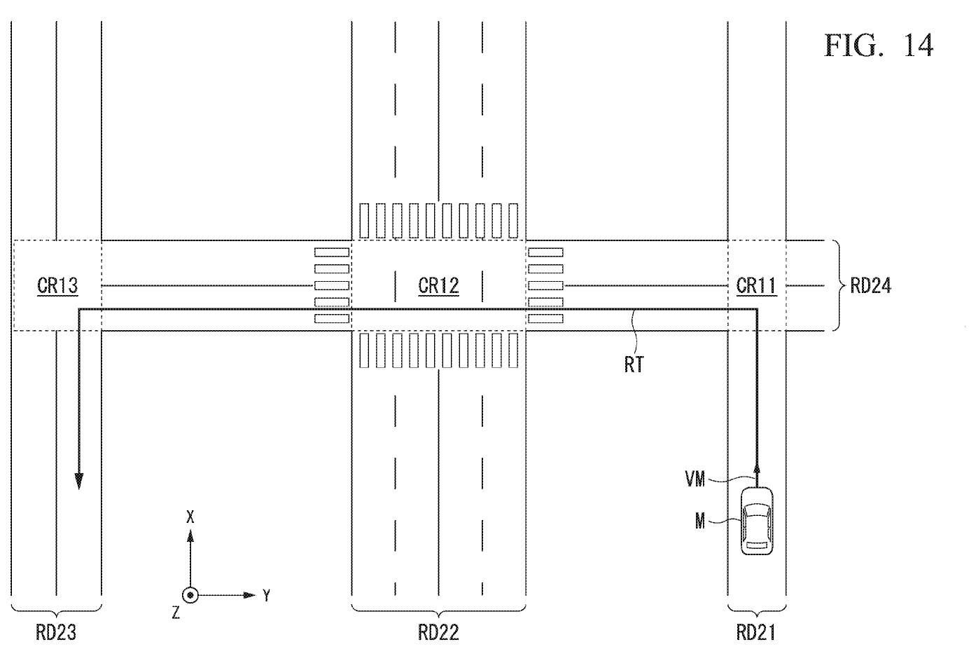

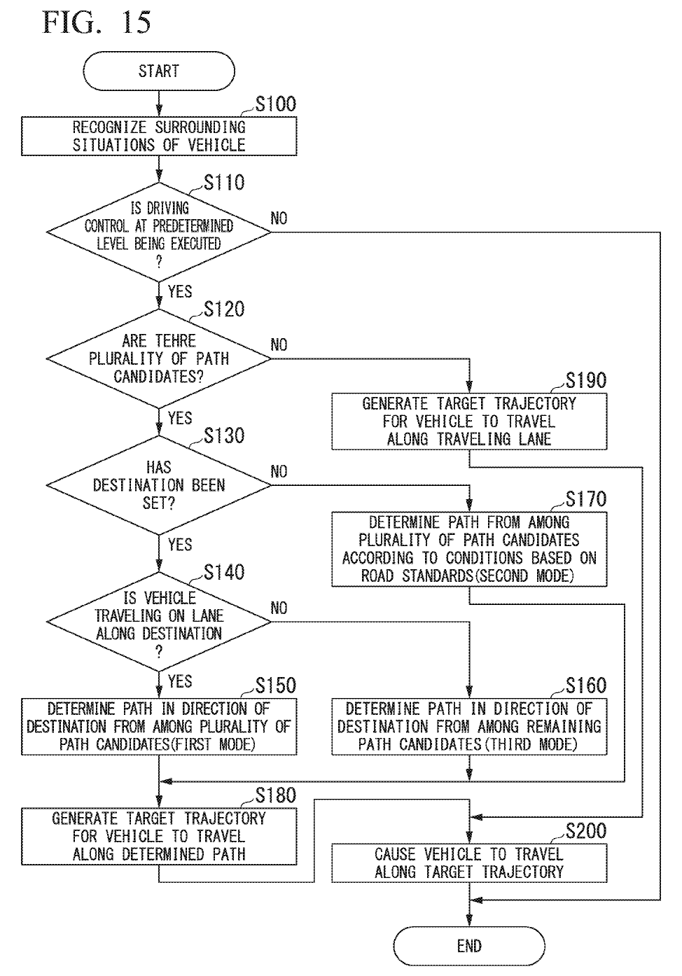

Next, an example of traveling along a road in a situation where a destination has not been set (there is no navigation route) will be described. FIG. 14 is a diagram illustrating an example of traveling along a road in a situation where a destination has not been set. The example of FIG. 14 illustrates a situation where a destination has not been set and the vehicle is automatically driven along a path (route RT) determined by the path determiner 153 along road shapes such as in an urban area. In the example of FIG. 14, three roads RD21, RD22, and RD23 extending in the X-axis direction in the drawing, and a road RD24 extending in the Y-axis direction in the drawing and connecting with the respective roads are shown. It is assumed that the roads RD21 and RD24 are connected at an intersection CR11, the roads R22 and RD24 are connected at an intersection CR12, and the roads RD23 and RD24 are connected at an intersection CR13. Also, it is assumed that the vehicle M is traveling on the road RD21 toward the intersection CR11 at a speed VM.

When an intersection CR11 with a plurality of path candidates exists within a predetermined distance in the traveling direction of the vehicle M, the path determiner 153 compares the priorities of the road standards or the road ranks of the roads RD21 and RD24, and since the road RD24 has a higher priority of the road standard, determines the road RD24 as the path, generates a target trajectory for turning left at the intersection CR11, and executes automated driving to turn left along the generated target trajectory.

Next, when an intersection CR12 with a plurality of path candidates exists within a predetermined distance in the traveling direction of the vehicle M, the path determiner 153 compares the priorities of the road standards of the roads RD22 and RD24. Here, although the road RD22 has a higher priority than the road RD24, since the priority of the road RD24 is equal to or higher than a predetermined value, the path determiner 153 determines the road RD24 on which the vehicle is currently traveling as the path. The action plan generator 140 generates a target trajectory for going straight through the intersection CR12 on the basis of the determined path, and executes automated driving to travel along the generated target trajectory.

Next, when an intersection CR13 with a plurality of path candidates exists within a predetermined distance in the traveling direction of the vehicle M, the path determiner 153 determines a path to proceed in a predetermined direction (a path that turns left) without comparing the priorities of the roads RD23 and RD24, because the road shape is a T-junction. The action plan generator 140 generates a target trajectory for turning left at the intersection CR13 and traveling on the road RD23, and executes automated driving to travel along the generated target trajectory.

In this way, by determining the path by the path determiner 153, even when the vehicle is traveling on a road shape with a plurality of path candidates in a situation where a destination has not been set, a more appropriate path can be determined, thereby enabling more appropriate driving control to be executed. Therefore, it is possible to reduce the discomfort felt by the occupants, and also to expand the range of candidate destinations since the vehicle can continue to travel along the road.

### Modification Examples

In addition, in the embodiment, when the acquirer 151 acquires information about the destination of the vehicle M through the operation by the occupant of the vehicle M while the vehicle is traveling on a path determined in the second mode by the path determiner 153 at the first driving level, the processor 154 may perform control to switch from the path determined in the second mode to the path determined in the first mode and cause the vehicle to travel along that path. This allows the path determination mode to be switched by the destination setting operation. In addition, when switching from the second mode to the first mode, the processor 154 may drive along a target trajectory generated on the basis of the path already determined in the second mode, and then determine a path using the first mode at the timing when a road shape with a plurality of path candidates exists within a predetermined distance in the traveling direction of the vehicle M. This makes it possible to curb the path (target trajectory) from being switched while the vehicle is traveling along the target trajectory.

In addition, in the embodiment, even when a destination has been set, the path determiner 153 may switch from the first mode to the second mode to determine the path when the acquirer 151 receives an instruction (occupant’s instruction) to determine the path in the second mode. This allows the vehicle to travel along a path in accordance with the intentions of the occupants.

In addition, in the embodiment, when the acquirer 151 acquires an instruction regarding a path direction from an occupant of the vehicle M while the vehicle M is traveling along a path determined in the first mode or the second mode, the processor 154 may perform control to cause the vehicle M to travel along the acquired path direction. This allows the vehicle M to travel with priority given to the intentions of the occupants.

In addition, in the embodiment, the traveling mode may include, in addition to the first and second modes described above, a third mode in which, when the path determined in the first mode is not drivable, a path in the direction of the destination is determined from the remaining path candidates among a plurality of path candidates. Accordingly, even when the vehicle M is unable to travel on the path to a direction of the destination due to, for example, traffic congestion or an accident, the path determiner 153 can use the third mode to determine a path that serves as a detour path, allowing the vehicle M to continue traveling in a direction of the destination as much as possible. In addition, since traffic congestion situations and accident information can be acquired from outside via the communication device 20 or determined on the basis of the recognition results by the recognizer 130, the path determiner 153 determines the path in the third mode when the path determined in the first mode is congested or an accident has occurred.

In addition, in the embodiment, the traveling mode may include, in addition to the first mode and second mode (or first to third modes) described above, a fourth mode in which, when the path determined in the second mode is not drivable, a path is determined from the remaining path candidates among a plurality of path candidates. In this case, the path determiner 153 determines, for example, the path with the highest priority from the remaining path candidates on the basis of the fourth mode. Accordingly, even when, during the second mode, the vehicle M is unable to travel on the path to a direction of the destination due to, for example, traffic congestion or an accident, the fourth mode can be used to determine path that serves as a detour path, allowing the vehicle M to continue traveling while avoiding getting caught in traffic as much as possible.

In addition, in the embodiment, when determining the path of the vehicle M in the second mode, the path determiner 153 may refer to the travel history information 194 stored in the storage 190 and determine the path on the basis of the travel history for each road standard included in the travel history information 194. In this case, the path with the highest travel frequency is determined from among the plurality of path candidates. This allows the vehicle to travel along a path that the occupant prefers.

In addition, when determining the path of the vehicle M in the second mode, the path determiner 153 may determine the path of the vehicle M on the basis of the number of lanes for each path among the plurality of path candidates. In this case, the path determiner 153 determines the path with the highest number of lanes on the basis of the number of lanes for each path obtained from the map information. This allows the vehicle to travel on roads that are less affected by traffic congestion, and since automated driving continues even when lane changes and the like are necessary, the burden on occupants is reduced and more appropriate driving control is achieved. Furthermore, the path determiner 153 may determine the path with the widest width on the basis of the width of the road (or lanes) instead of (or in addition to) the number of lanes. In addition, the path determiner 153 may set priorities corresponding to the number of lanes and width, and determine a path from a plurality of path candidates on the basis of the set priorities (or road ranks based on the priorities). In addition, the path determiner 153 may determine a path that continues the path (road) being traveled on from among a plurality of path candidates when the priority corresponding to the number of lanes and width of the road currently being traveled on is equal to or higher than a predetermined value.

Furthermore, in the above embodiment, the case has been described in which the left-hand traffic regulations are applied, but when the right-hand traffic regulations are applied, the left and right may simply be read in reverse. For example, when a T-junction exists in the traveling direction in a situation of the right-hand traffic, the path determiner 153 determines the road to which the vehicle will turn right as the path, regardless of road rules. In other words, when determining the path in the second mode, the path determiner 153 determines the path of the vehicle M from a plurality of path candidates that intersect the traveling lane of the vehicle M, on the basis of the current traveling situation of the vehicle M (left-hand traffic or right-hand traffic). Accordingly, it is possible to determine a path direction that reduces risk according to the traveling situation.

In addition, in determining a path in the embodiment, the route may loop depending on the road shape. Therefore, when the route loops a predetermined number of times or more, the path determiner 153 may determine a path that has not been selected previously and has a road shape where there are a plurality of next path candidates.

In addition, in the embodiment, the path determiner 153 may determine a path with a lower road rank or priority from among a plurality of path candidates, instead of determining a path with a higher road rank or priority. This allows the vehicle to travel on shortcuts and other roads that avoid traffic jams and other issues. Whether to determine a path with a high or low road rank or priority may be set according to the surrounding road conditions (for example, whether it is a suburban area or an urban area), or may be set on the basis of the instruction information of the occupant acquired via the HMI 30, etc.

### Process Flow

Processes executed by the automated driving control device 100 of the embodiment will be described later. FIG. 15 is a flowchart illustrating an example of a flow of processes executed by the automated driving control device 100. In the following, the description will be centered on the driving control process, including path determination, among the processes executed by the automated driving control device 100. The processes described later may be repeatedly executed at a predetermined timing or at a predetermined period, and may be repeatedly executed while the automated driving control device 100 is executing driving control.

In the example of FIG. 15, the recognizer 130 recognizes the surrounding situations of the vehicle M (step S100). Next, the driving level determiner 152 determines whether driving control at a predetermined level (for example, driving control at a first driving level) is being executed (step S110). When it is determined that the driving control at the predetermined level is being executed, the path determiner 153 determines whether there are a plurality of path candidates in the traveling direction of the vehicle M (step S120). When it is determined that there are a plurality of path candidates, the path determiner 153 determines whether a destination has been set (step S130). When it is determined that a destination has been set, the path determiner 153 determines whether the vehicle is traveling on a lane along the destination (a path in a direction of the destination) (step S140).

When it is determined that the vehicle is traveling on a lane that is aligned with the destination, the path determiner 153 determines, as a first mode, a path in a direction of the destination from among a plurality of path candidates (step S150). Furthermore, when it is determined in the process of step S140 that the vehicle is not traveling on a lane that is aligned with the destination (for example, the route in a direction of the destination cannot be traveled on), as a third mode, a path in a direction of the destination is determined from among the remaining path candidates (step S160).

Furthermore, when it is determined in the process of step S130 that a destination has not been set, the path determiner 153 determines, as a second mode, a path from among a plurality of path candidates according to conditions based on road standards (step S170).

After the process of step S150, S160, or S170, the action plan generator 140 generates a target trajectory for the vehicle M to travel along the determined path (step S180). Also, when it is determined in the process of step S120 that there are not a plurality of path candidates, the action plan generator 140 generates a target trajectory for the vehicle M to travel along the current traveling lane of the vehicle M (step S190). After the process of step S180 or step S190, the second controller 160 causes the vehicle M to travel along the generated target trajectory (step S200). Accordingly, the process of the present flowchart ends.

When it is determined in the process of step S110 that the driving control at the predetermined level is not being executed, the process of the present flowchart ends.

According to the above embodiment, the automated driving control device 100 (an example of a vehicle control device) includes the path determiner 153 configured to determine a path of the vehicle M according to a situation of the vehicle M; and a driving controller (the processor 154, the action plan generator 140, the second controller 160) configured to execute at least one of steering control and speed control of the vehicle M such that the vehicle M travels along the path determined by the path determiner 153, in which the path determiner 153 determines a path of the vehicle M using one of a plurality of determination modes, and the plurality of determination modes include a first mode in which, when a road shape with a plurality of path candidates exists in a traveling direction of the vehicle M and a destination of the vehicle M has been set, a path in a direction of the destination is determined from among the plurality of path candidates, and a second mode in which, when the road shape exists and a destination of the vehicle M has not been set, a path for the vehicle M to travel from among the plurality of path candidates is determined according to a condition based on a predetermined road standard. This makes it possible to determine a more appropriate path according to the situation of the vehicle. Therefore, more appropriate driving control can be executed. This can ultimately contribute to development of a sustainable transportation system.

For example, in automated driving in a situation where a destination has not been set (free drive mode), it is desirable to prioritize traveling on roads with wider road widths. However, depending on the traveling situation, traveling on wider roads may not be required, so that adjustments need be made within an appropriate range. Furthermore, when for some reason the vehicle travels on a road outside the guidance route and temporarily travels along the road, it may not be possible to travel on an appropriate path. Therefore, according to the embodiment, when there are a plurality of path candidates, the path is determined according to conditions based on road standards, which clarifies the conditions for determination, reducing the discomfort felt by occupants regarding driving control and allowing the vehicle to continue traveling along the road, thereby expanding the range of candidate destinations. Furthermore, according to the embodiment, the continuity of automated driving can be improved. Furthermore, according to the embodiment, the path is determined by comparing the priority corresponding to the road standard, the number of lanes on the road, the width, etc. with a predetermined value, thereby enabling the vehicle to travel along a more appropriate path.

The embodiment described above can be expressed as follows.

A vehicle control device including:

a storage medium configured to store computer-readable instructions; and

a processor connected to the storage medium,

in which the processor executes the computer-readable instructions to perform:

determining a path of a vehicle according to a situation of the vehicle;

executing at least one of steering control and speed control of the vehicle such that the vehicle travels along the determined path; and

determining the path of the vehicle using one of a plurality of determination modes, and

the plurality of determination modes include a first mode in which, when a road shape with a plurality of path candidates exists in a traveling direction of the vehicle and a destination of the vehicle has been set, a path in a direction of the destination is determined from among the plurality of path candidates, and a second mode in which, when the road shape exists and a destination of the vehicle has not been set, a path for the vehicle to travel is determined from among the plurality of path candidates according to a condition based on a predetermined road standard.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a path determiner configured to determine a path of a vehicle according to a situation of the vehicle; and
a driving controller configured to execute at least one of steering control and speed control of the vehicle such that the vehicle travels along the path determined by the path determiner,
wherein the path determiner determines the path of the vehicle using one of a plurality of determination modes, and
the plurality of determination modes include a first mode in which, when a road shape with a plurality of path candidates exists in a traveling direction of the vehicle and a destination of the vehicle has been set, a path in a direction of the destination is determined from among the plurality of path candidates, and a second mode in which, when the road shape exists and a destination of the vehicle has not been set, a path for the vehicle to travel is determined from among the plurality of path candidates according to a condition based on a predetermined road standard.

2. The vehicle control device according to claim 1, wherein the second mode is a mode in which a path that continues a current path of the vehicle is determined from among the plurality of path candidates when a priority of a road standard of a road on which the vehicle is traveling is equal to or higher than a predetermined value, or when a priority of a road standard of a road on which the vehicle is traveling and a priority of a road standard of the path candidate are equal to each other or do not differ by a predetermined value or more.

3. The vehicle control device according to claim 1, further comprising:
an acquirer configured to acquire an operation by an occupant of the vehicle,
wherein the driving controller, when the acquirer acquires information about the destination of the vehicle through the operation by the occupant while the vehicle is traveling along the path determined in the second mode by the path determiner, causes the vehicle to travel along the path determined in the first mode.

4. The vehicle control device according to claim 1, wherein the plurality of determination modes include
a third mode in which, when the vehicle is unable to travel on the path determined in the first mode, a path in the direction of the destination is determined from a remaining path candidate among the plurality of path candidates.

5. The vehicle control device according to claim 1, further comprising:
an acquirer configured to acquire an operation by an occupant of the vehicle,
wherein the driving controller, when the acquirer acquires an instruction of a path direction from the occupant of the vehicle while the vehicle is traveling along the path determined in the first mode or the second mode, causes the vehicle to travel along the acquired path direction.

6. The vehicle control device according to claim 1, further comprising:
an output controller configured to cause an output to output information about the path determined in the second mode.

7. The vehicle control device according to claim 1, wherein the path determiner, when determining the path in the second mode, determines the path of the vehicle from a plurality of path candidates that intersect a traveling lane of the vehicle, on the basis of a current traveling situation of the vehicle.

8. The vehicle control device according to claim 2, wherein the path determiner determines the predetermined value according to an instruction from an occupant of the vehicle.

9. The vehicle control device according to claim 1, wherein the path determiner determines the condition based on the road standard on the basis of a past travel history of the vehicle.

10. The vehicle control device according to claim 1, wherein the path determiner, when determining the path of the vehicle in the second mode, determines the path of the vehicle on the basis of the number of lanes or width for each path among the plurality of path candidates.

11. A vehicle control method that is executed by a computer, the vehicle control method comprising:
determining a path of a vehicle according to a situation of the vehicle;
executing at least one of steering control and speed control of the vehicle such that the vehicle travels along the determined path; and
determining the path of the vehicle using one of a plurality of determination modes,
wherein the plurality of determination modes include a first mode in which, when a road shape with a plurality of path candidates exists in a traveling direction of the vehicle and a destination of the vehicle has been set, a path in a direction of the destination is determined from among the plurality of path candidates, and a second mode in which, when the road shape exists and a destination of the vehicle has not been set, a path for the vehicle to travel is determined from among the plurality of path candidates according to a condition based on a predetermined road standard.

12. A non-transitory computer-readable storage medium that stores a program, the program causing a computer to execute:
determining a path of a vehicle according to a situation of the vehicle;
executing at least one of steering control and speed control of the vehicle such that the vehicle travels along the determined path; and
determining the path of the vehicle using one of a plurality of determination modes,
wherein the plurality of determination modes include a first mode in which, when a road shape with a plurality of path candidates exists in a traveling direction of the vehicle and a destination of the vehicle has been set, a path in a direction of the destination is determined from among the plurality of path candidates, and a second mode in which, when the road shape exists and a destination of the vehicle has not been set, a path for the vehicle to travel is determined from among the plurality of path candidates according to a condition based on a predetermined road standard.
